(19) United States
(12) Patent Application Publication
(10) Pub. No.: US 2017/0002708 A1
(43) Pub. Date: Jan. 5, 2017

(54) APPARATUS AND METHOD FOR CONTROLLING NITROGEN OXIDE SENSOR OF HYBRID VEHICLE

(71) Applicants: Hyundai Motor Company, Seoul (KR); KIA Motors Corporation, Seoul (KR)

(72) Inventor: Jeong Sik JIN, Ansan-si (KR)

(73) Assignees: Hyundai Motor Company, Seoul (KR); KIA Motors Corporation, Seoul (KR)

(21) Appl. No.: 14/939,801

(22) Filed: Nov. 12, 2015

(30) Foreign Application Priority Data
Jun. 30, 2015 (KR) 10-2015-0093609

(51) Int. Cl. F01N 3/20; F01N 13/00; B60K 6/22; F01N 11/00; B60K 6/442

(52) U.S. Cl. CPC F01N 3/208; F01N 11/007; B60K 6/442; B60K 6/22; F01N 13/008; Y10S 903/904; B60Y 2200/92; B60Y 2300/47; B60Y 2400/446; F01N 2550/05; F01N 2560/026; F01N 2560/20; F01N 2610/02; F01N 2900/1402

(57) ABSTRACT

A method of controlling a nitrogen oxide sensor of a hybrid vehicle includes: determining whether starting of a vehicle is turned on according to a manipulation of a starting switch; determining whether an engine is operating; determining whether a control condition of a nitrogen oxide sensor is satisfied; and measuring, if an engine is operating and if a control condition of a nitrogen oxide sensor is satisfied, a concentration of nitrogen oxide that is included in an exhaust gas by heating the nitrogen oxide sensor.

### CROSS-REFERENCE TO RELATED APPLICATION

This application claims the benefit of the Korean Patent Application No. 10-2015-0093609, filed on Jun. 30, 2015, which is incorporated herein by reference in its entirety.

### FIELD

The present disclosure relates to an apparatus and method for controlling a nitrogen oxide sensor of a hybrid vehicle.

### BACKGROUND

The statements in this section merely provide background information related to the present disclosure and may not constitute prior art.

Hybrid electric vehicles may form various structures using at least two power sources that are formed with an engine and a motor. The hybrid electric vehicle applies a Transmission Mounted Electric Device (TMED) method of a power train in which a motor, a transmission, and a drive shaft are coupled in series.

An engine clutch is provided between an engine and a motor, and a hybrid electric vehicle is driven in an Electric Vehicle (EV) mode or a Hybrid Electric Vehicle (HEV) mode according to whether the engine clutch is coupled.

The EV mode is a mode in which a vehicle drives with only a driving torque of a motor, and the HEV mode is a mode in which a vehicle drives with a driving torque of a motor and an engine. Therefore, when a hybrid electric vehicle drives, an engine may maintain an operation state or a stop state.

In an exhaust pipe in which an exhaust gas that is discharged from the engine flows, a selective catalytic reduction (SCR) catalyst is provided, and at the front end and the rear end of the SCR catalyst, nitrogen oxide (NOx) sensors are each provided to measure a concentration of nitrogen oxide (NOx) that is included in the exhaust gas. The nitrogen oxide sensor has a sensing unit and a heating unit.

In a state in which an engine is stopped, because an exhaust gas and nitrogen oxide are not discharged, it is unnecessary to control a nitrogen oxide sensor. However, when the engine is operated, an exhaust gas is discharged from a combustion chamber of the engine and thus it is necessary to control the nitrogen oxide sensor.

However, we have discovered that a conventional hybrid electric vehicle always controls heating and measurement of a heating unit of a nitrogen oxide sensor regardless of operation of an engine. That is, the hybrid electric vehicle continues to control a nitrogen oxide sensor from an on state to an off state of a starting switch. In this way, unnecessary heating of the heating unit shortens a life-span of the nitrogen oxide sensor and deteriorates fuel consumption due to power consumption.

### SUMMARY

The present disclosure provides a nitrogen oxide sensor control apparatus of a hybrid vehicle that controls a nitrogen oxide sensor in a condition in which an exhaust gas and nitrogen oxide are discharged during operation of an engine.

The present disclosure further provides a method of controlling a nitrogen oxide sensor of a hybrid vehicle using the apparatus that controls a nitrogen oxide sensor in a condition in which an exhaust gas and nitrogen oxide are discharged during operation of an engine.

An exemplary embodiment of the present disclosure provides a method of controlling a nitrogen oxide sensor of a hybrid vehicle including: determining whether starting of a vehicle is turned on according to a manipulation of a starting switch; determining whether an engine is operating; determining whether a control condition of a nitrogen oxide sensor is satisfied; and measuring, if an engine is operating and if a control condition of a nitrogen oxide sensor is satisfied, a concentration of nitrogen oxide that is included in an exhaust gas by heating the nitrogen oxide sensor.

The control condition of the nitrogen oxide sensor may be satisfied, if a temperature of an exhaust gas is higher than a dew point temperature.

The method may further include: determining at a predetermined time interval whether the engine is operating while measuring a concentration of nitrogen oxide that is included in the exhaust gas by the nitrogen oxide sensor; and measuring a concentration of nitrogen oxide that is included in the exhaust gas by the nitrogen oxide sensor only when the engine is operating.

The method may further include determining, if an engine is not operating, whether a starting switch is in an off state.

The method may further include terminating, if the starting switch is in an off state, the control of a nitrogen oxide sensor that measures a concentration of nitrogen oxide that is included in an exhaust gas by heating the nitrogen oxide sensor.

The method may further include reducing nitrogen oxide through an SCR catalyst by ejecting a reducing agent to an exhaust gas through an injection module while measuring a concentration of nitrogen oxide that is included in the exhaust gas by the nitrogen oxide sensor.

The method may further include terminating, when the control of the nitrogen oxide sensor is terminated, ejection of a reducing agent through an injection module that is provided in the exhaust gas.

Another embodiment of the present disclosure provides a nitrogen oxide sensor control apparatus of a hybrid vehicle including: an exhaust pipe in which an exhaust gas that is discharged from an engine flows; a selective catalytic reduction (SCR) catalyst that is installed in the exhaust pipe to reduce nitrogen oxide that is included in an exhaust gas; an exhaust temperature sensor that is installed at the front end of the SCR catalyst to measure a temperature of an exhaust gas and a dew point temperature; a first nitrogen oxide sensor and second nitrogen oxide sensor that are installed at the front end and the rear end, respectively, of the SCR catalyst to measure a concentration of nitrogen oxide that is included in the exhaust gas; and a controller that controls measuring a concentration of nitrogen oxide that is included in the exhaust gas by heating the nitrogen oxide sensor while the engine is operating and if a control condition of the nitrogen oxide sensor is satisfied.

The controller may determine that the control condition is satisfied, if a temperature of an exhaust gas that is measured by the exhaust temperature sensor is greater than a dew point temperature.

The controller may determine at a predetermined time interval whether the engine is operating while measuring a concentration of nitrogen oxide that is included in the exhaust gas by the nitrogen oxide sensor and measure a concentration of nitrogen oxide that is included in the exhaust gas by the nitrogen oxide sensor only when the engine is operating.

The controller may terminate the control of a nitrogen oxide sensor that measures a concentration of nitrogen oxide that is included in an exhaust gas by heating the nitrogen oxide sensor, when the engine is not operating and when a starting switch is in an off state.

The controller may temporarily stop the control of the nitrogen oxide sensor until the engine operates, when the engine is not operating and when the starting switch is in an on state.

In another form, the controller may stop the measuring of the concentration of nitrogen oxide in the exhaust gas when the vehicle is operated under an electric vehicle mode, and maintains a standby state to resume the measuring of the concentration of nitrogen oxide in the exhaust gas until the electric vehicle mode is converted to an hybrid vehicle mode.

As described above, according to an exemplary embodiment of the present disclosure, by providing first and second nitrogen oxide sensors at the front end and the rear end of an SCR catalyst, in a condition in which an exhaust gas and nitrogen oxide are discharged during operation of an engine, heating and measurement of the first and second nitrogen oxide sensors can be controlled.

That is, in a condition in which nitrogen oxide is not discharged, because a heating unit of first and second nitrogen oxide sensors is not heated, a life-span of the first and second nitrogen oxide sensors can be extended. Therefore, fuel consumption can be improved.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of a hybrid vehicle according to one form of the present disclosure;

FIG. 2 is a schematic diagram of an exhaust pipe in a hybrid vehicle according to the present disclosure;

FIG. 3 is a block diagram illustrating a configuration of a nitrogen oxide sensor control apparatus of a hybrid vehicle according to the present disclosure;

FIG. 4 is a flowchart illustrating a method of controlling a nitrogen oxide sensor of a hybrid vehicle according to the present disclosure; and

FIG. 5 is a schematic view illustrating a configuration of a nitrogen oxide sensor according to an exemplary embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As those skilled in the art would realize, the described embodiments may be modified in various different ways, all without departing from the spirit or scope of the present disclosure.

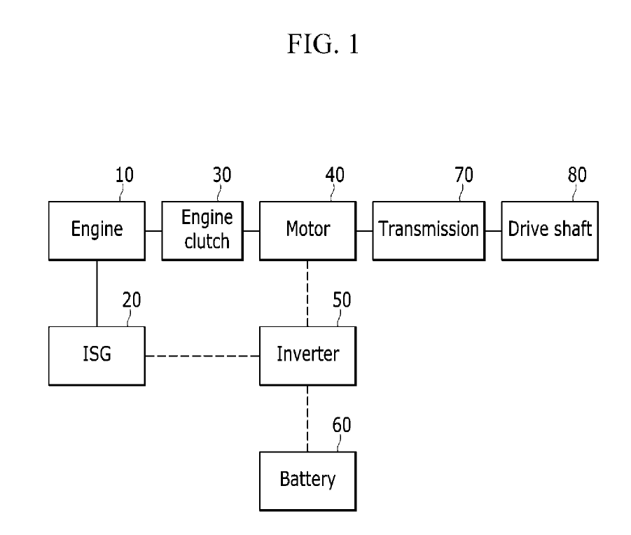

Referring to FIG. 1, the hybrid vehicle may include an engine 10, an Integrated Starter and Generator (ISG) 20, an engine clutch 30, power electronic components 40, 50, and 60, a transmission 70, and a drive shaft 80. The hybrid vehicle may include a plug-in hybrid vehicle.

An apparatus and method for controlling a nitrogen oxide sensor of a hybrid vehicle according to the present disclosure are used in, for example, a plug-in hybrid vehicle. However, the present disclosure is not limited thereto and may be applied to a hybrid vehicle of other methods.

The engine 10 generates a driving torque by combustion of fuel and may include a gasoline engine, a diesel engine, a Liquefied Petroleum Gas (LPG) engine, a methanol engine, or a hydrogen engine.

The power electronic components 40, 50, and 60 generate a driving torque by power and include a motor 40, an inverter 50, and a battery 60.

The motor 40 receives an input of power from the battery 60 to generate a driving torque. The motor 40 may be selectively connected to the engine 10 through the engine clutch 30 to receive a driving torque that is generated in the engine 10. Further, the motor 40 is connected to the transmission 70 to transfer a driving torque of the engine 10 and/or a driving torque of the motor 40 to the transmission 70.

The inverter 50 converts DC power of the battery 60 to AC power and applies AC power to the motor 40. Further, the inverter 50 converts AC power that is generated by a rotation of the motor 40 or the ISG 20 to DC power and applies DC power to the battery 60. Thereby, the battery 60 is charged.

The battery 60 is charged with DC power and supplies DC power to the inverter 50 or receives the supply of DC power from the inverter 50.

The ISG 20 is connected to the engine 10 and starts the hybrid vehicle or drives the engine 10 in a lower engine speed.

The engine clutch 30 is disposed between the engine 10 and the motor 40 to selectively connect the engine 10 to the motor 40. That is, when the engine clutch 30 is operated, the engine 10 is connected to the motor 40 to transfer a driving torque of the engine 10 to the motor 40. Alternatively, when the engine clutch 30 is not operated, the engine 10 is not connected to the motor 40.

The transmission 70 is connected to the motor 40 and receives a driving torque of the engine 10 and/or a driving torque of the motor 40. The transmission 70 changes a magnitude of a driving torque that is received from the engine 10 and/or the motor 40 (by changing a rotation speed according to a synchronized gear ratio).

The drive shaft 80 transfers a driving torque that is received from the transmission 70 to a wheel (not shown) to enable driving of the hybrid vehicle. Although not shown, a differential is provided between the transmission 70 and the drive shaft 80.

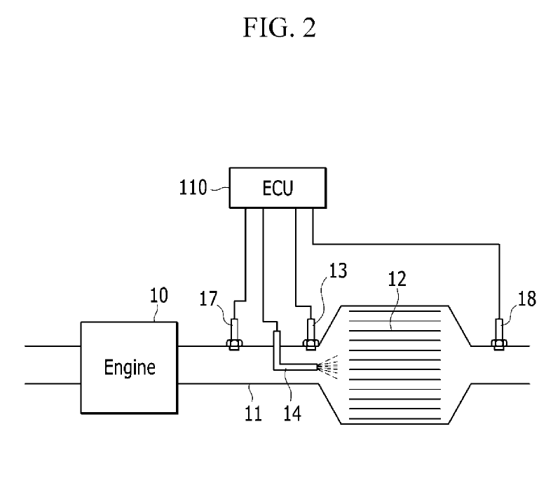

FIG. 2 is a schematic diagram of an exhaust pipe in a hybrid vehicle according to an exemplary embodiment of the present disclosure. Referring to FIG. 2, an exhaust pipe 11 is connected to an exhaust manifold (not shown) of the engine 10 to discharge an exhaust gas to the outside of the vehicle. In the exhaust pipe 11, a selective catalytic reduction (SCR) catalyst 12, an exhaust temperature sensor 13, an injection module 14, and first and second nitrogen oxide sensors 17 and 18 are provided.

The SCR catalyst 12 is mounted in the exhaust pipe 11 and reduces nitrogen oxide that is included in an exhaust gas using a reducing agent.

The exhaust temperature sensor 13 is mounted in the exhaust pipe 11 at the front end of the SCR catalyst 12 to measure an exhaust gas temperature at the front end of the SCR catalyst 12 for the control of the SCR catalyst 12 and the control of the first and second nitrogen oxide sensors 17 and 18. That is, the exhaust temperature sensor 13 senses a dew point temperature within the exhaust pipe 11. Although not shown, the exhaust temperature sensor may be mounted within the SCR catalyst to measure a temperature of an exhaust gas within the SCR catalyst.

In order to measure a dew point temperature of an exhaust gas, the exhaust temperature sensor 13 may include a wet and dry bulb thermometer or a dew point hygrometer.

In order to supply a reducing agent to the SCR catalyst 12, the injection module 14 may directly eject urea water or may eject ammonia. Further, the injection module 14 may eject other reducing agents other than ammonia together with ammonia or may eject only other reducing agents.

Although not shown, a urea tank and a urea pump are connected to the injection module 14. That is, urea water that is pumped from a urea water tank by pumping of the urea pump is ejected into the exhaust pipe 11 through the injection module 14 to be mixed with an exhaust gas and to be injected into the SCR catalyst 12.

Urea water that is ejected to the exhaust gas is decomposed into ammonia by a heat of the exhaust gas, and the decomposed ammonia operates as a reducing agent for nitrogen oxide. In the present disclosure, ejection of a reducing agent includes ejection of a material to be a reducing agent by the injection module 14.

The first nitrogen oxide sensor 17 is mounted in the exhaust pipe 11 at the front end of the SCR catalyst 12 and measures a concentration of nitrogen oxide (NOx) that is included in an exhaust gas at the front end of the SCR catalyst 12. A concentration of nitrogen oxide that is included in the exhaust gas of the front end of the SCR catalyst 12 that is measured by the first nitrogen oxide sensor 17 is transmitted to an ECU 110. That is, the first nitrogen oxide sensor 17 measures a concentration of nitrogen oxide that is included in the exhaust gas that is discharged from the engine 10.

The second nitrogen oxide sensor 18 is mounted in the exhaust pipe 11 at the rear end of the SCR catalyst 12 and measures a concentration of nitrogen oxide (NOx) that is included in the exhaust gas at the rear end of the SCR catalyst 12. A concentration of nitrogen oxide that is included in the exhaust gas of the front end of the SCR catalyst 12 that is measured by the second nitrogen oxide sensor 18 is transmitted to the ECU 110. That is, the second nitrogen oxide sensor 18 measures a concentration of nitrogen oxide that is included in the exhaust gas in which nitrogen oxide is reduced by passing through the SCR catalyst 12.

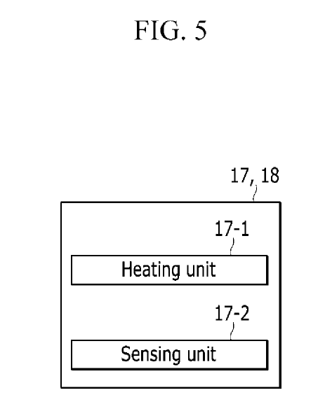

As shown in FIG. 5, the first and second nitrogen oxide sensors 17 and 18 include a heating unit 17-1 that heats to a predetermined temperature (e.g., 780° C. at first) for sensing and a sensing unit 17-2 that senses a concentration of nitrogen oxide that is included in the exhaust gas after heating.

In order to sense a concentration of nitrogen oxide, high power is applied to the heating unit of the first and second nitrogen oxide sensors 17 and 18. In order to safely detect a concentration of nitrogen oxide that is included in the exhaust gas by the nitrogen oxide sensor, high power that is applied to the heating unit should not be transferred to the sensing unit. When a temperature of an exhaust gas corresponds to a dew point temperature, it may be determined that dew is formed at the inside of the nitrogen oxide sensor. In such a case, because the heating unit and the sensing unit are electrically connected, high power for the heating unit may be transferred to the sensing unit.

In order to prevent such a problem, before heating the heating unit, the exhaust temperature sensor 13 detects a dew point temperature of an exhaust gas, converts the detected dew point temperature to an electrical signal, and transmits the electrical signal to the ECU 110.

If a temperature of an exhaust gas corresponds to a dew point temperature, when the engine 10 is stopped, it is determined that dew is formed within the exhaust pipe 11 and the heating unit is not heated. If a temperature of an exhaust gas is higher than a dew point temperature, when the engine 10 is stopped, it is determined that dew is not formed within the exhaust pipe 11 and the heating unit is heated.

A hybrid vehicle according to an exemplary embodiment of the present disclosure that is described hereinafter illustrates a structure of a Transmission Mounted Electric Device (TMED) method. However, the present disclosure is not limited thereto and may be applied to a hybrid electric vehicle of other methods.

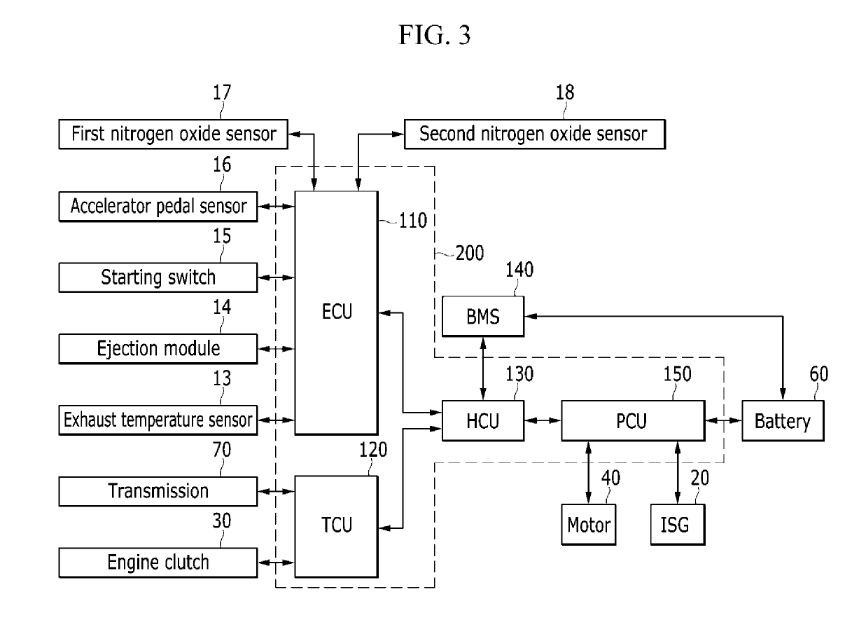

FIG. 3 is a block diagram illustrating a configuration of a nitrogen oxide sensor control apparatus of a hybrid vehicle according to an exemplary embodiment of the present disclosure. Referring to FIG. 3, a nitrogen oxide sensor control apparatus of a hybrid vehicle includes an Engine Control Unit (ECU) 110, a Transmission Control Unit (TCU) 120, a Hybrid Control Unit (HCU) 130, a Battery Management System (BMS) 140, and a Power Control Unit (PCU) 150.

The ECU 110 interlocks with the HCU 130 that is connected to a network to control an entire operation of the engine 10. At the ECU 110, the exhaust temperature sensor 13, the injection module 14, a starting switch 15, an accelerator pedal sensor 16, and the first and second nitrogen oxide sensors 17 and 18 for controlling the SCR catalyst 12 are connected. The accelerator pedal sensor 16 detects a manipulation of an accelerator pedal. An accelerator pedal change amount that is detected by the accelerator pedal sensor 16 is provided to the ECU 110.

By controlling an actuator that is provided in the transmission 70 according to the control of the HCU 130 that is connected to a network, the TCU 120 controls gear shift to a target gear shift stage and controls a pressure of a fluid that is supplied to the engine clutch 30 to execute engagement and release of the engine clutch 30, thereby connecting or releasing delivery of driving power of the engine 10.

The HCU 130 is a top superordinate controller and controls an entire operation of the hybrid vehicle by an integral control of subordinate controllers that are connected to a network. For example, the HCU 130 may determine an acceleration intention of a driver from an accelerator pedal change amount that is detected by the accelerator pedal sensor 16 and converts a driving mode of the hybrid vehicle from an EV mode to an HEV mode according to an acceleration intention of a driver.

The BMS 140 detects information such as a voltage, a current, and a temperature of the battery 60, manages a charge state of the battery 60, and controls a charging current amount or a discharge current amount of the battery 60 not to be over-discharged to a limit voltage or less or not to be overcharged to a limit voltage or more.

The PCU 150 includes a inverter 50 and a protection circuit that are formed with a Motor Control Unit (MCU) and a plurality of power switching elements and converts DC power that is supplied from the battery 60 to AC power according to a control signal that is applied from the HCU 130, thereby controlling driving of the motor 40.

Further, the PCU 150 charges the battery 60 using power that is generated by the motor 40. The ECU 110, the TCU 120, the HCU 130, the BMS 140, and the PCU 150 may be generally divided into respective control modules, but in this specification, it is described that the ECU 110, the TCU 120, the HCU 130, the BMS 140, and the PCU 150 are integrated into one controller. That is, a controller of the present exemplary embodiment includes the ECU 110, the TCU 120, the HCU 130, the BMS 140, and the PCU 150.

The controller may be provided with at least one processor operating by a predetermined program, and the predetermined program performs each step of a method of controlling a nitrogen oxide sensor of a hybrid vehicle according to an exemplary embodiment of the present disclosure.

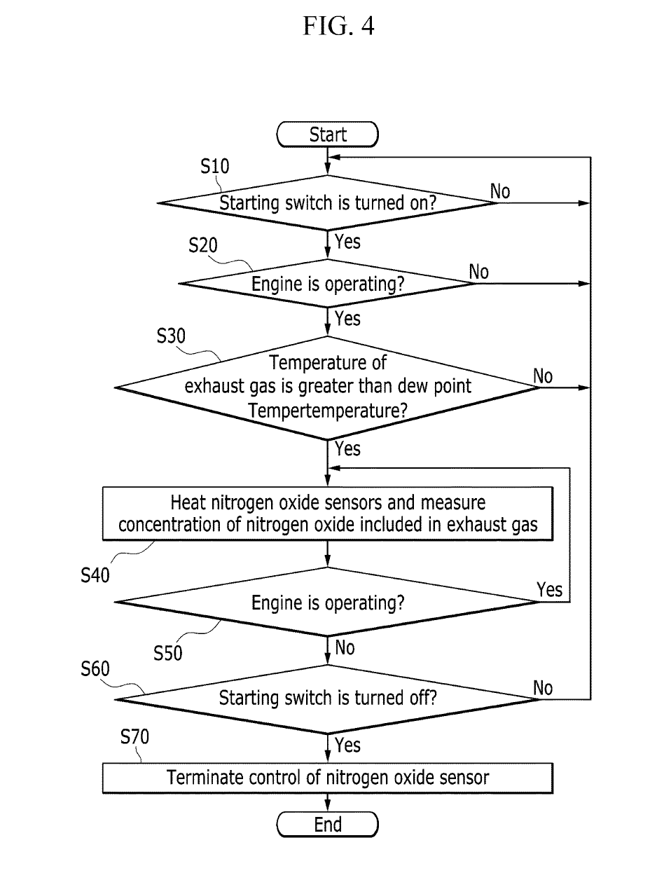

FIG. 4 is a flowchart illustrating a method of controlling a nitrogen oxide sensor of a hybrid vehicle according to an exemplary embodiment of the present disclosure.

Referring to FIG. 4, a controller 200 determines whether starting of a vehicle is turned on according to a signal occurring by a manipulation of the starting switch 15 of a driver (S10).

If starting of the vehicle is turned on, the controller 200 determines whether the engine 10 is operating (S20).

If the engine 10 is operating, the controller 200 determines whether a control condition of the nitrogen oxide sensors 17 and 18 is satisfied.

In this case, if a temperature of an exhaust gas that is measured through the exhaust temperature sensor 13 that is installed in the exhaust pipe 11 is greater than a dew point temperature, the controller 200 determines that a control condition of the nitrogen oxide sensors 17 and 18 is satisfied (S30).

If a temperature of an exhaust gas flowing the exhaust pipe 11 is lower than a dew point temperature, there is a very high possibility that dew is to form at the inside of the nitrogen oxide sensors 17 and 18 that are installed in the exhaust pipe 11.

That is, if a temperature of an exhaust gas is lower than a dew point temperature, there is a high possibility that a heating unit and a sensing unit of the nitrogen oxide sensors 17 and 18 will be electrically connected. Therefore, as high power for heating a heating unit of the nitrogen oxide sensors 17 and 18 may be transferred to the sensing unit, there is high danger that the nitrogen oxide sensor is to be damaged.

Therefore, if a temperature of an exhaust gas substantially corresponds to a dew point temperature, the controller 200 does not heat a heating unit of the nitrogen oxide sensors 17 and 18 and does not measure a concentration of nitrogen oxide that is included in the exhaust gas through the nitrogen oxide sensors 17 and 18.

If a control condition of the nitrogen oxide sensors 17 and 18 is satisfied at step S30, the controller 200 measures a concentration of nitrogen oxide that is included in the exhaust gas by the nitrogen oxide sensors 17 and 18.

In this way, if a temperature of an exhaust gas flowing the inside of the exhaust pipe 11 is higher than a dew point temperature, there is a very low possibility that dew will form in the heating unit and the sensing unit of the nitrogen oxide sensors 17 and 18 and thus by heating the heating unit of the nitrogen oxide sensors 17 and 18, the controller 200 may safely measure a concentration of nitrogen oxide through the nitrogen oxide sensors 17 and 18 (S40).

While measuring a concentration of nitrogen oxide that is included in the exhaust gas through the nitrogen oxide sensors 17 and 18, the controller 200 ejects a reducing agent to an exhaust gas through the injection module 14 that is installed in the exhaust pipe 11, and an SCR catalyst reduces nitrogen oxide that is included in the exhaust gas.

The controller 200 may determine intrinsic identification (ID) of the nitrogen oxide sensors 17 and 18 by a signal that is transmitted from the nitrogen oxide sensors 17 and 18.

In this way, because at the front end of the SCR catalyst, the first nitrogen oxide sensor 17 is installed and at the rear end of the SCR catalyst, the second nitrogen oxide sensor 18 is installed, ID determination of the nitrogen oxide sensors 17 and 18 is to determine which nitrogen oxide sensor (i.e., the front nitrogen oxide sensor 17 or the rear nitrogen oxide sensor 18) detects the concentration of nitrogen oxide.

While measuring a concentration of nitrogen oxide by heating the nitrogen oxide sensors 17 and 18, the controller 200 determines whether an engine is operating at every predetermined time (S50).

For example, the controller 200 determines whether the engine 10 is operating at every second interval. If the engine 10 is operating, the controller 200 continues to measure a concentration of nitrogen oxide by heating the nitrogen oxide sensors 17 and 18.

If an engine is not operated, the controller 200 determines whether the starting switch 15 of the vehicle is turned off (S60). If the starting switch 15 is turned on, the process continues at step S20.

That is, when the engine 10 is not operating, a mode of the vehicle is converted from a hybrid vehicle (HEV) mode to an electric vehicle (EV) mode and thus the vehicle may be in a driving state with only a driving torque of the motor 40.

Therefore, in such a case, the controller 200 does not measure a concentration of nitrogen oxide that is included in the exhaust gas by heating the nitrogen oxide sensors 17 and 18 but maintains a standby state until the engine 10 is operating (e.g., until a mode of the vehicle is converted from an EV mode to an HEV mode).

That is, in a state that does not measure a concentration of nitrogen oxide through the nitrogen oxide sensors 17 and 18 instead of heating a heating unit of the nitrogen oxide sensors 17 and 18, until the engine 10 is operated, the controller 200 temporarily stops the control of the nitrogen oxide sensor. Here, the control of the nitrogen oxide sensor is to measure a concentration of nitrogen oxide that is included in the exhaust gas by heating the nitrogen oxide sensors 17 and 18.

Therefore, when the engine 10 is operated, the controller 200 may immediately heat the heating unit of the nitrogen oxide sensors 17 and 18 to measure a concentration of nitrogen oxide that is included in the exhaust gas.

If the starting switch 15 of the vehicle is turned off at step S60, the controller 200 terminates the control of the nitrogen oxide sensor that measures a concentration of nitrogen oxide that is included in the exhaust gas (S70).

In this case, the controller 200 terminates to eject a reducing agent to an exhaust gas through the injection module 14.

As described above, according to an apparatus and method for controlling a nitrogen oxide sensor according to an exemplary embodiment of the present disclosure, when an engine is operating and only when a control condition of a nitrogen oxide sensor (e.g., a condition in which a temperature of an exhaust gas is higher than a dew point temperature) is satisfied, the controller measures a concentration of nitrogen oxide that is included in the exhaust gas by heating the nitrogen oxide sensor.

That is, when the engine is not operating and when a control condition of a nitrogen oxide sensor is not satisfied, the nitrogen oxide sensor is not heated. That is, because the nitrogen oxide sensor is not unnecessarily heated, a life-span of the nitrogen oxide sensor is extended and unnecessary power is not consumed and thus fuel consumption of the vehicle can be improved.

While this present disclosure has been described in connection with what is presently considered to be practical exemplary embodiments, it is to be understood that the present disclosure is not limited to the disclosed embodiments, but, on the contrary, is intended to cover various modifications and equivalent arrangements included within the spirit and scope of the appended claims.

### DESCRIPTION OF SYMBOLS

| 10: engine | 11: exhaust pipe |
|---|---|
| 12: SCR catalyst | 13: exhaust temperature sensor |
| 14: injection module | 15: starting switch |
| 16: accelerator pedal sensor | 17: first nitrogen oxide sensor |
| 18: second nitrogen oxide sensor | |
| 20: integrated starter-generator (ISG) | |
| 30: engine clutch | 70: transmission |
| 80: drive shaft | 40: motor |
| 50: inverter | 60: battery |
| 110: ECU | 120: TCU |
| 130: HCU | 140: BMS |
| 150: PCU | |

What is claimed is:

1. A method of controlling a nitrogen oxide sensor of a hybrid vehicle, the method comprising:
determining whether starting of a vehicle is turned on according to a manipulation of a starting switch;
determining whether an engine is operating;
determining whether a control condition of a nitrogen oxide sensor is satisfied; and
measuring, a concentration of nitrogen oxide in an exhaust gas by heating the nitrogen oxide sensor when the engine is operating and the control condition of the nitrogen oxide sensor is satisfied.

2. The method according to claim 1, wherein the control condition of the nitrogen oxide sensor is satisfied when a temperature of the exhaust gas is higher than a dew point temperature.

3. The method according to claim 1, further comprising:
determining at a predetermined time interval whether the engine is operating while measuring the concentration of nitrogen oxide in the exhaust gas by the nitrogen oxide sensor; and
measuring the concentration of nitrogen oxide in the exhaust gas by the nitrogen oxide sensor only when the engine is operating.

4. The method according to claim 3, further comprising determining whether the starting switch is in an off state if an engine is not operating.

5. The method according to claim 4, further comprising terminating, when the off state of the starting switch is determined, the control of the nitrogen oxide sensor that measures the concentration of nitrogen oxide in the exhaust gas by heating the nitrogen oxide sensor.

6. The method according to claim 5, further comprising terminating, when the control of the nitrogen oxide sensor is terminated, ejection of a reducing agent through an injection module that is provided in the exhaust gas.

7. The method according to claim 1, further comprising reducing nitrogen oxide through a selective catalytic reduction (SCR) catalyst by ejecting a reducing agent to the exhaust gas through an injection module while measuring the concentration of nitrogen oxide in the exhaust gas by the nitrogen oxide sensor.

8. A nitrogen oxide sensor control apparatus of a hybrid vehicle, the nitrogen oxide sensor control apparatus comprising:
an exhaust pipe through which an exhaust gas discharged from an engine flows;
a selective catalytic reduction (SCR) catalyst that is installed in the exhaust pipe to reduce nitrogen oxide in the exhaust gas;
an exhaust temperature sensor that is installed at a front end of the SCR catalyst configured to measure a temperature of the exhaust gas and a dew point temperature;
first and second nitrogen oxide sensors installed at a front end and a rear end of the SCR catalyst, respectively, and configured to measure a concentration of nitrogen oxide in the exhaust gas; and
a controller configured to control measuring of the concentration of nitrogen oxide in the exhaust gas by heating the nitrogen oxide sensors while the engine is operating and when a control condition of the nitrogen oxide sensor is satisfied.

9. The nitrogen oxide sensor control apparatus according to claim 8, wherein the controller determines that the control condition of the nitrogen oxide sensor is satisfied when a temperature of the exhaust gas that is measured by the exhaust temperature sensor is greater than a dew point temperature.

10. The nitrogen oxide sensor control apparatus according to claim 8, wherein the controller determines at a predetermined time interval whether the engine is operating while measuring the concentration of nitrogen oxide in the exhaust gas by the nitrogen oxide sensors, and the measuring the concentration of nitrogen oxide is performed only when the engine is operating.

11. The nitrogen oxide sensor control apparatus according to claim 10, wherein the controller terminates the control of the nitrogen oxide sensors that measure the concentration of nitrogen oxide in the exhaust gas by heating the nitrogen oxide sensors when the engine is not operating and also a starting switch is in an off state.

12. The nitrogen oxide sensor control apparatus according to claim 11, wherein the controller temporarily stops the control of the nitrogen oxide sensors until the engine operates when the engine is not operating and also the starting switch is in an on state.

13. The nitrogen oxide sensor control apparatus according to claim 8, wherein the controller stops the measuring of the concentration of nitrogen oxide in the exhaust gas when the vehicle is operated under an electric vehicle mode, and maintains a standby state to resume the measuring of the concentration of nitrogen oxide in the exhaust gas until the electric vehicle mode is converted to an hybrid vehicle mode.
